(19) United States
(12) Patent Application Publication
(10) Pub. No.: US 2004/0177091 A1
(43) Pub. Date: Sep. 9, 2004

(54) Digital content managing method and apparatus

(76) Inventors: Kozo Akiyoshi, Tokyo (JP); Nobuo Akiyoshi, Tokyo (JP)

Correspondence Address: Dowell & Dowell, P.C., Suite 309, 1215 Jefferson Davis Highway, Arlington, VA, 22202, US

(21) Appl. No.: 10/041,503

(22) Filed: Jan. 10, 2002

(30) Foreign Application Priority Data
Jan. 10, 2001 (JP) 2001-2071

(51) Int. Cl. G06F 17/00

(52) U.S. Cl. 707/104.1

(57) ABSTRACT

A method and apparatus in which original digital content is input. First copyright information on the input original content is acquired and if a user is authorized to alter the original content, image processing and/or audio processing is performed on the content, either in a predetermined manner or as directed by the user, to generate secondary content. Thereafter, both the first copyright information for the original content and second copyright information for the secondary content are associated with or imprinted into the secondary content. The secondary content is then registered in a database in such a manner that the secondary content is associated with the original content.

### BACKGROUND OF THE INVENTION

1. Field of the Invention

The present invention relates to a digital content managing technology, and more particularly relates to a method and apparatus for managing the copyright of digital content.

2. Description of the Related Art

With advanced digital technologies, network infrastructure and information equipment, unprecedented amounts of digital content are being produced and distributed today. Digital content, which has excellent signal to noise resistance and various other advantages because of its digital nature, is expected to continue to be an expanding market. However, there is a serious problem concerns content creators and distributors, and it is the problem of copyright. In other words, digital content can be easily copied (“pirated”) by using PCs and other hardware readily available today. Unless this problem is solved, further development and distribution of digital content may be hindered or reduced significantly.

A technique conventionally known in coping with this piracy problem is “watermarking” by which copyright information is imprinted into the content. Generally, certain data on the original copyright holder is watermarked in the content, so that the ownership can be identified when the contents are illegally copied.

### SUMMARY OF THE INVENTION

Content is generally something that is delivered by a larger organization to ordinary users for their enjoyment. Recently, however, a new culture has been growing where ordinary users are beginning to create content by themselves, producing computer graphic (CG) images or showing in their home pages some artistic photographs they have taken with their own digital cameras. Moreover, with the wider use of image processing tools, there are increased occasions where people adapt or alter images they have shot themselves or downloaded from Web sites or other sources by processing them by themselves. The present invention has been made in view of the foregoing circumstances and an object thereof is to provide a digital content managing technology in response to these new situations.

An embodiment of the present invention relates to a digital content managing method. This method includes: acquiring an original content; performing a predetermined image processing or audio processing on the original content; and recording, in a secondary content generated by the processing, both first copyright information for the original content and second copyright information for the secondary content.

According to another embodiment, a content managing method includes: acquiring an original content; performing a predetermined image processing or audio processing on the original content; and recording, in a secondary content generated by the processing, second copyright information for the secondary content, while first copyright information for the original content are maintained therein.

Just as there may be copyright in the original content, there may also be copyright in the secondary content. When some original content is altered by image processing or audio processing, there is a possibility that such alteration may be questioned and be in conflict with the right to alter the content. On the other hand, when the original content is altered so much that almost no trace of the aesthetic or other factors of the original remains, it may be determined that the original content has “lost” its copyright altogether. Furthermore, if a copyright in the secondary content has already arisen, then there is a need for a scheme by which the copyright of the secondary content is protected. In each of these cases, it is important to identify who the copyright claimant is with regard to the original content and the secondary content.

Accordingly, the present embodiment provides a scheme of recording, inside and/or outside the digital content, necessary information which is, in this case, the first copyright information and the second copyright information to identify copyright claimants, while subjective judgment on copyrights is put into the hands of the appropriate authorities. It is to be appreciated here that there are not only the active case but also the passive case of recording or retaining the first copyright information. In other words, if some copyright information remains recorded in content unless it is actively erased, such a situation is also considered within the range of intent of the present invention.

In another embodiment according to the present invention, at least parts of the first copyright information and the second copyright information may be imprinted as a watermark into the secondary content. The watermark may be visible or audible, or otherwise. In other words, the watermark may be such that it is either perceptible or imperceptible in relation to the content itself. Moreover, the second copyright information may contain information on the processing. For example, the second copyright information may contain information that indicates the elements of image processing performed, such as cutting, scaling, rotation, color change and other arbitrary processings. And, in this case, the relationship of such image processing with the original content becomes clearer. The same is similarly applicable to audio processing.

The method according to the present invention may further include: examining, prior to the processing, to see whether a user who intends to perform the processing has a right to alter the original content; and permitting the user to perform the processing only when the user who intends to performs the processing has the right to alter the original content. In this embodiment, the right to alter the content can be checked strictly and thus violation of the copyright by alteration can be prevented. In a particular case, the determination of whether or not a user has a right to alter the original content may include obtaining payment or determining if payment has been made. Further, the payment may include an amount related to the original content, such as, for example, a royalty payment relating to use of the original content.

The method according to the present invention may further include: registering in a database the secondary content and the original content in such a manner as to be interrelated with each other. In this way, the relationship between the original content and the secondary content become clearer, which may be useful in terms of copyright management; in particular, in a situation where there may be an interaction in which a high value of one of the contents may be reflected in the value of the other.

Another embodiment relates to a digital content managing apparatus. This apparatus includes: an input unit which acquires an original content; a main processing unit which performs a predetermined image processing or audio processing on the original content; and an imprinting unit which records, in a secondary content generated by the main processing unit, both first copyright information for the original content and second copyright information for the secondary content.

In still another embodiment, there is provided a digital content managing apparatus that includes: an input unit which acquires an original content; a main processing unit which performs a predetermined image processing or audio processing on the original content; and an imprinting unit which records, in a secondary content generated by the main processing unit, second copyright information for the secondary content, while first copyright information for the original content is kept therein.

Still another embodiment relates also to a digital content managing apparatus. This apparatus includes an imprinting unit which, after a predetermined image processing or audio processing is performed on an original content, records both first copyright information for the original content and second copyright information for a secondary content, in the secondary content generated by the processing.

In still another embodiment, there is provided a digital content managing apparatus which includes an imprinting unit which, after a predetermined image processing or audio processing is performed on an original content, records second copyright information for a secondary content in the secondary content generated by the processing while first copyright information for the original content, if any, is maintained therein.

According to another aspect of the present invention, there is provided a digital content managing method that includes acquiring an original content; performing a predetermined image processing or audio processing on the original content to generate a secondary content; and recording the secondary content in a database such that the secondary content is associated with the original content.

In a particular case, the method may also include recording copyright information in the database in association with the secondary content. In this case, the copyright information may include first copyright information for the original content and second copyright information for the secondary content.

In another particular case, the method may also include obtaining a payment. In this case, the payment may include a payment related to the original content, such as, for example, a royalty payment or the like related to copyright for the original content.

According to another aspect of the present invention, there is provided a digital content managing method that includes acquiring an original content; performing a predetermined image processing or audio processing on the original content to generate a secondary content; recording the secondary content and related copyright information in a database such that the secondary content is associated with the original content; obtaining a payment; and outputting the secondary content.

It is to be noted that any arbitrary addition to replacement or substitution of the above-described structural components and elements or processes may be made. The structural components, elements and processes replaced or substituted in part or whole between a method and an apparatus or changed to a computer program that realizes those structural components, elements or processes and a recording medium or the like that records such the computer program are all effective as and encompassed by the present embodiments.

Moreover, this summary of the invention does not necessarily describe all necessary features so that the invention may also be a sub-combination of these described features.

### BRIEF DESCRIPTION OF THE DRAWINGS

FIG. 1 shows a structure of a content managing apparatus according to an embodiment of the present invention.

FIG. 2 is a flowchart showing a processing procedure for the content managing apparatus of FIG. 1.

FIGS. 3A, 3B and 3C illustrate copyright information provided in content, according to embodiment of the present invention.

### DETAILED DESCRIPTION OF THE INVENTION

The invention will now be described based on the embodiments, which are not intended to limit the scope of the present invention, but exemplify the invention. All of the features and the combinations thereof described in the embodiment are not necessarily essential to the invention.

As has already been described, when secondary content is prepared from and based on original content, it is desirable that both of the contents be managed. According to the present embodiments hereinbelow, copyright information for the original content (hereinafter referred to as first copyright information or simply as FCI) and copyright information for the secondary content itself (hereinafter referred to as second copyright information or simply as SCI) are both imprinted or embedded into the secondary content.

Moreover, as an example of image processing which may be performed on the content, a technology (referred to as “base technology” hereinafter) which was proposed in Japanese Patent No. 2927350 owned by the same assignee is utilized. In the base technology, a matching between two key frames is computed using critical points, corresponding points between those key frames are detected pixel by pixel, and, based on results thereof, an interpolation computation is performed, so as to generate an intermediate frame or frames between the key frames. Thus, smooth motion pictures between key frames, morphing images, viewpoint changing images and so forth can be generated. In this patent specification, the key frames are considered as the original content while the intermediate frames are considered as the secondary content.

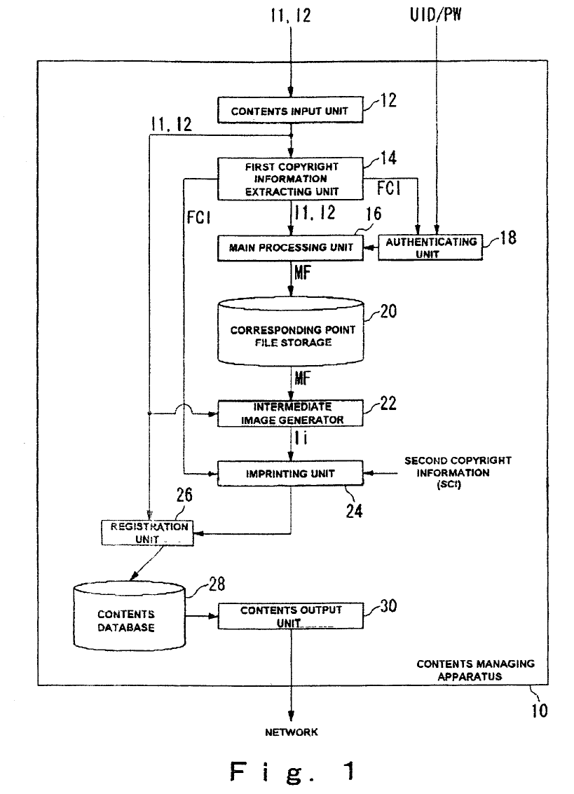

FIG. 1 shows a structure of a content managing apparatus 10 according to an embodiment of the present invention. A content input unit 12 receives or acquires two key frames I1 and I2. A first copyright information extracting unit 14 extracts the first copyright information FCI from the key frames and sends it to an imprinting unit 24 described later. The key frames themselves are sent to a main processing unit 16.

The main processing unit 16, which is a processor that carries out processing and, in this embodiment, according to the base technology, detects critical points through a two-dimensional search in each of the key frames, and specifies sets of corresponding pixels between the two key frames. A corresponding point file MF thus generated is stored in a corresponding point file storage 20.

In this embodiment, an optional authenticating unit 18 is provided in the apparatus 10, and the authenticating unit 18 authenticates a user who performs this image processing, for example, based on user identification information UID and a password PW. When the authenticated user is authorized to alter the original content, such as a copyright holder indicated in the first copyright information FCI, the authenticating unit 18 allows processing by the main processing unit 16.

An intermediate image generator 22 performs interpolation on the position and the pixel value or values, for example, color, between the corresponding pixels, based on data of the two key frames I1 and I2 and the corresponding point file MF, and generates an intermediate frame Ii at an arbitrary temporal or spatial position between the key frames. The intermediate frame Ii thus generated is output to the imprinting unit 24.

The imprinting unit 24 imprints the first copyright information FCI and the second copyright information SCI as watermarks on the intermediate frame Ii. The second copyright information SCI may be preset, such as an ID assigned by software or hardware to a particular content managing apparatus 10, and/or input by a user, such as information on a user who utilizes the content managing apparatus 10. In any case, the intermediate frame Ii, which is content imprinted with copyright information, is then registered in a content database 28 by an operation of a registration unit 26. The registration unit 26 registers the intermediate frame Ii and the two key frames I1 and I2 in such a way that the intermediate frame Ii is associated with the two original key frames I1 and I2.

A content output unit 30 outputs the intermediate frame I1 and/or the key frames I1 and I2 associated therewith to an arbitrary destination, such as a display, a network or storage. Thus, the content output unit 30 may have a communication function, a memory control function and/or a display control function therein and the content output unit 30 may be structured so as to serve its intended purposes.

In a particular case, the authenticating unit 18 or content output unit 30 may also obtain payment from a user of the content managing apparatus 10 of charges for the use of the content managing apparatus and allow the processing or the output of the contents only after payment has been made. Such payments may be obtained in various ways, such as, for example credit card payment. In a particular case, the charges for the processing may include an amount to be paid to the copyright holder or the like for the original content.

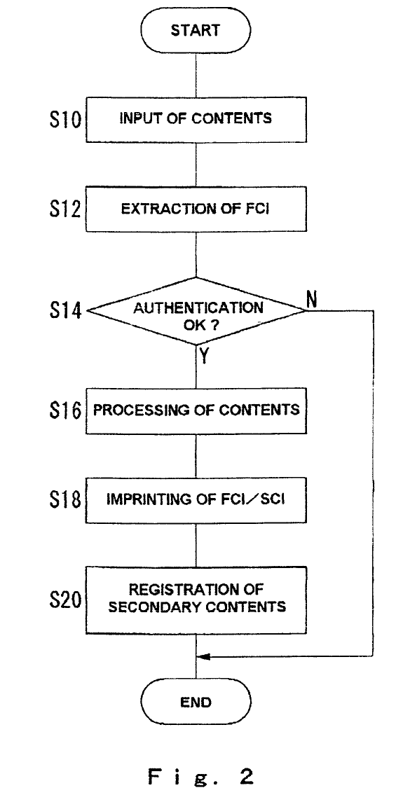

FIG. 2 is a flowchart showing a somewhat generalized procedure performed by this content managing apparatus 10. First the content input unit 12 receives or acquires original content (S10). Then the first copyright information FCI is extracted or acquired from the content (S12). Then user authentication is carried out (S14), and when it can be determined that the user has the right to alter the content (Y in S14) through payment or otherwise, permission is given for the processing of the content by the main processing unit 16 (S16). However, when a determination cannot be made that the user has the right to alter the content, or when the user does not have the right to alter the contents (N in S14), the process is terminated.

After processing of the content by the main processing unit 16 (s16), the imprinting unit 24 imprints the first copyright information FCI and the second copyright information SCI into the generated secondary content (S18), and finally the registration unit 26 registers the secondary content together with the original content in the content database 28 (S20).

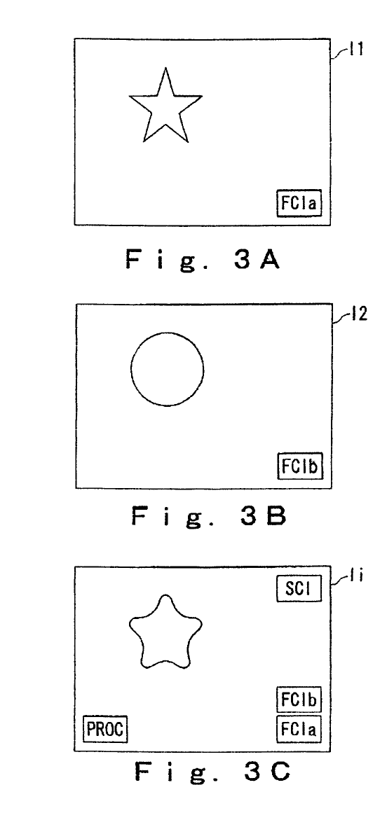

FIGS. 3A, 3B and 3C show example images of a first key frame I1, a second key frame I2 and a generated intermediate frame Ii, respectively. As can be seen in the figures, the intermediate frame Ii is an image intermediate between the two key frames I1 and I2. The first key frame I1 and the second key frame I2 are imprinted with their respective original copyright information, namely, the first copyright information FCIa and FCIb (which may be the same if the key frames I1 and I2 have the same copyright holder or claimant), and the intermediate frame Ii is imprinted with the second copyright information SCI in addition thereto. Moreover, processing information PROC which shows the substance of processing added to the original content is also imprinted to the intermediate frame Ii.

The first copyright information FCI and the second copyright information SCI may include, for example, the name of a creator, the owner of distribution rights and the owners of other copyright or related rights, the date of creation, the place of creation, the title of the content, the format of the original data, a statement concerning the copyright, such as conditions for the renouncement of the copyright, and other bibliographical information.

The processing information PROC on the substance of processing may include, for example, details of processing, such as adjustment of color balance, conversion to monochrome, filtering, lowering of resolution, edge enhancement, interpolation as in the base technology, outline of manual editing, synthesis of CG with actually taken photographs, other syntheses and so forth. Similarly, processing information on audio processing may include any arbitrary processing by known technologies.

Since a description of these items of processing can become very long, elements of processing may make use of encoding or the like so as to enable a briefer description.

For example, high-pass filtering may be written or encoded as “HPF,” and rotation by 30 degrees as “ROT+30.” These elements of processing may be acquired from a processing log file which logs processing performed by the content managing apparatus 10 and they may be included in the second copyright information

Although the present invention has been described based on preferred embodiments, the present invention is not limited to and by them. Various modifications thereto are possible and may include at lease, the following example modifications.

Although the content managing apparatus 10 according to the preferred embodiments performs image processing by itself, it may acquire secondary content after the image processing by some external means and then imprint or embed the first copyright information FCI and the second copyright information SCI into this acquired secondary content.

The first copyright information extracting unit 14 may be removed or structured such that no data is sent to the imprinting unit 24 as the first copyright information FCI. In this case, the imprinting unit 24 writes the second copyright information SCI only. The advantage of this type of modification lies in that there will be no inconvenience caused even if there is no first copyright information FCI in the original content and further, even if there is first copyright information FCI, the first copyright information FCI is likely to have a high probability of remaining unless an active erasure step is taken.

Although the image matching and generation of an intermediate image are used as an example of a processing of the contents in the above embodiment, this may of course be any arbitrary processing which may be not only image processing but also any arbitrary audio processing. For example, it may be the cutting of a part of a movie, or a change in the arrangement of a piece of music insofar as secondary content different from the original content is generated.

In the present embodiments, the first copyright information extracting unit 14 extracts the first copyright information FCI from the original content. But when the original content includes not only content data but also a reference or management region, such as header data, the first copyright information FCI may be acquired from the management region, not specifically from the content data themselves. The FCI may also be acquired from a route and source (not shown) completely different from the original content, via a network or the like.

Similarly, the imprinting unit 24 is not always required to directly imprint the copyright information into the data itself of secondary content, but may imprint it in the management region of the content or may store it in a data region related to a site relating to the content such as, for example, the content database 28 or a network or web based database or the like.

Although still images are used as an example in the present embodiments, these embodiments may of course be applied to moving pictures. One example may be a newly generated movie in which all the human characters in the original have been replaced by animals. Moreover, a data format as being content may be changed completely, such as in cases where still images are changed to moving pictures and moving pictures are transformed into music based on their images or frequencies, and so forth.

Although the present invention has been described by way of exemplary embodiments, it should be understood that many changes and substitutions may further be made by those skilled in the art without departing from the scope of the present invention which is defined by the appended claims.

What is claimed is:

1. A digital content managing method, including:
acquiring an original content;
performing a predetermined image processing or audio processing on the original content; and
recording, in a secondary content generated by said performing the processing, both first copyright information for the original content and second copyright information for the secondary content.

2. A digital content managing method, including:
acquiring an original content;
performing a predetermined image processing or audio processing on the original content; and
recording, in a secondary content generated by said performing the processing, second copyright information for the secondary content, while first copyright information for the original content is maintained therein.

3. A method according to claim 1, wherein at least part of the first copyright information and the second copyright information is imprinted into the secondary content as a watermark.

4. A method according to claim 1, wherein the second copyright information includes information on the processing.

5. A method according to claim 1, further including:
examining, prior to the processing, whether or not a user who intends to perform the processing has a right to alter the content; and
permitting execution of the processing only when the user who intends perform the processing has the right.

6. A method according to claim 5, wherein said right to alter the content comprises having made a payment.

7. A method according to claim 1, further including
registering the secondary content and the original content in a database in such a manner that the secondary content and the original content are associated.

8. A digital content managing apparatus, comprising:
an input unit which acquires an original content;
a main processing unit which performs a predetermined image processing or audio processing on the original content; and
an imprinting unit which records, in a secondary content generated by said main processing unit, both first copyright information for the original content and second copyright information for the secondary content.

9. A content managing apparatus, comprising:
an input unit which acquires an original digital content;
a main processing unit which performs a predetermined image processing or audio processing on the original content; and
an imprinting unit which records, in a secondary content generated by said main processing unit, second copyright information for the secondary content, while first copyright information for the original content is maintained therein.

10. An apparatus according to claim 8, wherein at least part of the first copyright information and the second copyright information is imprinted into the secondary content as a watermark.

11. An apparatus according to claim 8, wherein the second copyright information includes information on the processing.

12. An apparatus according to claim 8, further comprising:
an authenticating unit which examines, prior to the processing, whether or not a user who intends to perform the processing has a right to alter the original content and permits execution of the processing only when the user has the right.

13. An apparatus according to claim 12, wherein said authenticating unit obtains a payment from the user to provide the right to alter the original content.

14. An apparatus according to claim 8, further comprising:
a registration unit which registers the secondary content and the original content in a database in such a manner that the secondary content and the original content are associated.

15. A content managing apparatus, including:
an imprinting unit which, after a predetermined image processing or audio processing is performed on an original content to generate secondary content, records both first copyright information for the original content and second copyright information for the secondary content in the secondary content.

16. A content managing apparatus, including:
an imprinting unit which, after a predetermined image processing or audio processing is performed on an original content, records second copyright information for a secondary content in the secondary content generated by the processing while first copyright information for the original content is maintained therein.

17. A computer program executable by a computer, the program comprising the functions of:
acquiring an original content;
performing a predetermined image processing or audio processing on the original content; and
recording, in a secondary content generated by said performing the processing, both first copyright information for the original content and second copyright information for the secondary content.

18. A computer program executable by a computer, the program comprising the functions of:
acquiring an original content;
performing a predetermined image processing or audio processing on the original content; and
recording, in a secondary content generated by said performing the processing, second copyright information for the secondary content, while first copyright information for the original content is maintained therein.

19. A digital content managing method, comprising:
acquiring an original content;
performing a predetermined image processing or audio processing on the original content to generate a secondary content; and
recording the secondary content in a database such that the secondary content is associated with the original content.

20. A method according to claim 19, further comprising:
recording copyright information in the database in association with the secondary content.

21. A method according to claim 20, wherein the copyright information comprises first copyright information for the original content and second copyright information for the secondary content.

22. A method according to claim 19, further comprising obtaining a payment.

23. A method according to claim 22, where said payment comprises a payment related to the original content.

24. A digital content managing method, comprising:
acquirig an original content; performing on the original content to generate a secondary content;
recording the secondary content and related copyright information in the database such that the secondary content is associated with the original content
obtaining a payment;
outputting the secondary content.
